(19) United States
(12) Patent Application Publication
(10) Pub. No.: US 2020/0002650 A1
(43) Pub. Date: Jan. 2, 2020

(54) FORMULATION COMPRISING POLYMER PARTICLES AND A METHOD OF TREATING A SUBSTRATE WITH SAID FORMULATION IN A LIQUID MEDIUM

(71) Applicant: Xeros Limited, Rotherham, South Yorkshire (GB)

(72) Inventors: Paul Lars Fredrik SERVIN, Rotherham (GB); Elizabeth Jean ABERCROMBIE, Glasgow (GB)

(21) Appl. No.: 16/481,583

(22) PCT Filed: Jan. 25, 2018
(86) PCT No.: PCT/GB2018/050204

§ 371 Date: Jul. 29, 2019

(30) Foreign Application Priority Data
Jan. 27, 2017 (GB) 1701401.0

(51) Int. Cl. C11D 3/37; C11D 3/12; C11D 17/06; C11D 11/00; C14C 11/00

(52) U.S. Cl. CPC C11D 3/3788; C11D 3/122; C14C 11/003; C11D 11/0017; C11D 17/06

(57) ABSTRACT

A formulation comprising a multiplicity of solid polymer particles, wherein said polymer is selected from polyamide and polyester, wherein a polyalkylene glycol is covalently attached to said polymer at the surface of said polymer particles; and a method for treating a substrate comprising agitating the substrate with said formulation and a liquid medium, particularly wherein the method of treating is a laundry method.

This invention relates to an improved treatment formulation and method for treating a substrate, particularly a substrate which is or comprises a textile. The invention also relates to a cleaning formulation and method for laundry cleaning of soiled substrates. This invention also relates to an apparatus suitable for performing said method.

The use of polymer particles in cleaning methods is known in the art. For example PCT patent publication WO2007/128962 discloses a method for cleaning a soiled substrate using a multiplicity of polymeric particles. Other PCT patent publications which have related disclosures of cleaning methods include: WO2012/056252, WO2014/006424; WO2015/0004444; WO2014/06425, WO 2012/035343 and WO2012/167545. WO2017/017455 is directed to improving cleaning performance and inhibiting dye transfer over repeated wash cycles, and discloses cleaning formulations comprising thermoplastic polyamide cleaning particles and a hydrophilic material at least part of which is located inside the cleaning particles, for instance polyamide particles comprising a polyether or a polyether block polyamide which is suitably co-extruded with the polyamide during manufacture of the polyamide particles. The properties of various block copolymers of polyamide-6 and polyethylene glycol have been studied by Fakirov et al., Makromol. Chem., 1992, 193, 2391.

These disclosures teach methods for cleaning a soiled substrate which offers several advantages over conventional laundry methods including: improved cleaning performance and/or reduced water consumption and/or reduced detergent consumption and/or better low temperature (and thus more energy efficient) cleaning.

It is known to use a hydrophilic material such as polyethylene glycol as a coupling agent to chemically combine the desirable properties of two, otherwise separate materials. Thus, WO 2015/078943 discloses nano-particles and micro-particles (for instance, particles of melamine/urea-formaldehydes, silicates or zeolites) which encapsulate a benefit agent such as a perfume wherein a polyethylene glycol “spacer” is attached to the surface of the particle and a peptide-based deposition aid is attached to the other end of the spacer, wherein the deposition aid functions to increase the deposition of the benefit agent-containing particle to the intended substrate.

It would be desirable to achieve even better performance characteristics for cleaning methods which use polymer particles. In particular, the present inventors desired to solve one or more of the following technical problems:
I. To reduce the mechanical damage of substrates during the cleaning process. Mechanical damage includes pilling damage caused to the surface of the substrate during washing. Garments and other substrates may have applied on their surface a transfer or sticker (for example a logo, image, wording or other motif applied to the fabric, for instance via a lamination or other adhesive technique, such as a heat-sensitive adhesive, well known in the apparel industry) and these transfers or stickers are particularly prone to damage, in all types of washing machines
II. To keep the colours of textiles brighter for longer and to inhibit the colour fade which often tends to follow repeated cleaning.
III. To inhibit shrinkage of textiles during the cleaning process.
IV. To provide a technical solution offering any one or more of the above advantages over many cleaning cycles.

According to a first aspect of the present invention, there is provided a formulation comprising a multiplicity of solid polymer particles, wherein said polymer is selected from polyamide and polyester, wherein a polyalkylene glycol is covalently attached to said polymer at the surface of said polymer particles.

According to a second aspect of the invention, there is provided a formulation comprising a multiplicity of solid polymer particles, wherein said polymer is selected from polyamide and polyester, wherein a polyalkylene glycol is covalently attached to said polymer at the surface of said polymer particles such that the polymer matrix of said polymer particles consists of monomeric repeating units linked by amide and/or ester linkages, wherein at least one terminus of at least one polymer chain is terminated by said covalently attached polyalkylene glycol at the surface of said polymer particles.

Thus, where the polymer of the polymer particle is a polyamide, the polymer matrix of said polymer particles consists of monomeric repeating units linked by amide linkages, Where the polymer of the polymer particle is a polyester, the polymer matrix of said polymer particles consists of monomeric repeating units linked by ester linkages, Where the polymer of the polymer particle is a blend or copolymer of a polyamide and a polyester, the polymer matrix of said polymer particles consists of monomeric repeating units linked by amide and ester linkages,

Preferably the formulation of the first and second aspects is a treatment formulation, preferably a cleaning formulation.

Preferably the solid particles of the first and second aspects are solid cleaning particles.

Without being limited by theory, it was surprisingly observed that one or more of the problem(s) noted above can be reduced or avoided by the use of polymer particles having a polyalkylene glycol (PAG) covalently attached to a surface thereof. In addition, it was not at all predictable that such modified particles would exhibit such improved fabric care over many treatment or wash cycles.

According to a third aspect of the present invention, there is provided a method for treating a substrate, the method comprising agitating the substrate with a formulation according to the first or second aspects of the invention and a liquid medium.

The substrate may be or comprise a textile and/or an animal skin substrate. In a preferred embodiment, the substrate is or comprises a textile. In a further embodiment, the substrate is or comprises a glass or ceramic or metal substrate.

The treating of a substrate which is or comprises a textile according to the present invention may be a cleaning process or any other treatment process such as coloration (preferably dyeing), ageing or abrading (for instance stone-washing), bleaching or other finishing process. Stonewashing is a known method for providing textiles having “worn in” or “stonewashed” characteristics such as a faded appearance, a softer feel and a greater degree of flexibility. Stonewashing is frequently practiced with denim. Preferably the treating of a substrate which is or comprises a textile is a cleaning process

As used herein, the term “treating” in relation to treating an animal skin substrate is preferably a tannery process, including colouring and tanning and associated tannery processes, preferably selected from curing, beamhouse treatments, pre-tanning, tanning, re-tanning, fat liquoring, enzyme treatment, tawing, crusting, dyeing and dye fixing, preferably wherein said beamhouse treatments are selected from soaking, liming, deliming, reliming, unhairing, fleshing, bating, degreasing, scudding, pickling and depickling. Preferably, said treating of an animal skin substrate is a process used in the production of leather. Preferably, said treating acts to transfer a tanning agent (including a colourant or other agent used in a tannery process) onto or into the animal skin substrate.

Preferably, the method is a method for treating multiple batches, wherein a batch comprises at least one substrate, the method comprising agitating a first batch with a formulation according to the first or second aspects of the invention and a liquid medium, wherein said method further comprises the steps of:

(a) recovering said particles;
(b) agitating a second batch comprising at least one substrate and a formulation comprising the particles recovered from step (a) and a liquid medium; and
(c) optionally repeating steps (a) and (b) for subsequent batch(es) comprising at least one substrate.

The treatment procedure of an individual batch typically comprises the steps of agitating the batch with said formulation and a liquid medium in a treatment apparatus for a treatment cycle. A treatment cycle typically comprises one or more discrete treatment step(s), optionally one or more rinsing step(s), optionally one or more step(s) of separating the particles from the treated batch, optionally one or more drying step(s), optionally one or more extraction step(s) of removing the liquid medium from the treated batch, and optionally the step of removing the treated batch from the treatment apparatus.

In the method of the present invention, steps (a) and (b) may be repeated at least 1 time, preferably at least 2 times, preferably at least 3 times, preferably at least 5 times, preferably at least 10 times, preferably at least 20 times, preferably at least 50 times, preferably at least 100 times, preferably at least 200 times, preferably at least 300 times, preferably at least 400 at least or preferably at least 500 times.

Preferably the liquid medium is an aqueous medium.

Preferably, the method of the third aspect of the invention is a method for cleaning a substrate, preferably a method for cleaning a substrate which is or comprises a textile.

Preferably, a batch is a washload.

Thus, preferably, the method is a method for cleaning multiple washloads, wherein a washload comprises at least one substrate (preferably wherein the substrate is or comprises a textile), the method comprising agitating a first washload with a cleaning formulation according to the first or second aspects of the invention and a liquid medium, wherein said method further comprises the steps of:

(a) recovering said particles;
(b) agitating a second washload comprising at least one substrate and a cleaning formulation comprising the particles recovered from step (a) and a liquid medium (preferably wherein said substrate is or comprises a textile); and
(c) optionally repeating steps (a) and (b) for subsequent washload(s) comprising at least one substrate (preferably wherein the substrate is or comprises a textile).

The cleaning procedure of an individual washload typically comprises the steps of agitating the washload with said cleaning formulation and a liquid medium in a cleaning apparatus for a cleaning cycle. A cleaning cycle typically comprises one or more discrete cleaning step(s) and optionally one or more post-cleaning treatment step(s), optionally one or more rinsing step(s), optionally one or more step(s) of separating the cleaning particles from the cleaned washload, optionally one or more drying step(s), optionally one or more extraction step(s) of removing the liquid medium from the cleaned washload, and optionally the step of removing the cleaned washload from the cleaning apparatus.

Preferably the washload comprises at least one soiled substrate, preferably wherein the soiled substrate is or comprises a soiled textile.

The soil may be in the form of, for example, dust, dirt, foodstuffs, beverages, animal products such as sweat, blood, urine, faeces, plant materials such as grass, and inks and paints.

The particularly surprising aspect of the present invention is that the modified particles retain the afore-mentioned improvements when used to clean multiple batches, particularly in an aqueous medium. In particular, the modified particles retain the afore-mentioned improvements in fabric care when used to clean multiple washloads of soiled substrate(s) in an aqueous medium. The recovery and re-use of the particles according to the method of the present invention to treat multiple batches does not require the re-introduction or re-application or re-attachment of the PAG onto the polymer particle. Thus, in the method of the present invention, PAG need not be re-introduced or re-applied or re-attached onto the polymer particles between batches (or washloads), i.e. before re-use of the particle to treat a subsequent batch (or washload).

According to a fourth aspect of the present invention, there is provided a method of reducing the mechanical damage and/or shrinkage and/or colour fade of a substrate in a treatment process which comprises agitating the substrate with solid polymeric particles and a liquid medium, wherein the method comprises agitating said substrate with a formulation according to the first or second aspects of the invention and a liquid medium.

Preferably, the fourth aspect of the present invention is a method of reducing the mechanical damage and/or shrinkage and/or colour fade of a substrate in a cleaning process which comprises agitating the substrate with solid polymeric particles and a liquid medium, particularly wherein the substrate is or comprises a textile, wherein the method comprises agitating said substrate with a cleaning formulation according to the first or second aspects of the invention and a liquid medium.

According to a fifth aspect of the present invention, there is provided the use of a formulation according to the first or second aspects of the invention for treating a substrate.

Preferably, the fifth aspect of the present invention is the use of a cleaning formulation according to the first or second aspects of the invention for cleaning a substrate, particularly a substrate which is or comprises a textile.

According to a sixth aspect of the present invention, there is provided the use of a formulation according to the first or second aspects of the invention for reducing the mechanical damage and/or shrinkage and/or colour fade of a substrate in a treatment process which comprises agitating the substrate with said formulation and a liquid medium.

Preferably, the sixth aspect of the present invention is the use of a cleaning formulation according to the first or second aspects of the invention for reducing the mechanical damage and/or shrinkage and/or colour fade of a substrate in a cleaning process which comprises agitating the substrate with said cleaning formulation and a liquid medium, particularly wherein the substrate is or comprises a textile.

The preferences and embodiments of the first and second aspects of the invention are applicable also to the third aspect of the invention. The preferences and embodiments of the first, second and third aspects of the invention are applicable also to the fourth, fifth, sixth, seventh, eighth and ninth aspects of the invention described hereinbelow.

One or more substrates can be simultaneously treated by the method of the invention. The exact number of substrates will depend on the size of the substrates and the capacity of the apparatus utilized.

The total weight of dry substrates treated at the same time (i.e. in a single batch or washload) may be up to 50,000 kg. For textile substrates, the total weight is typically from 1 to 500 kg, more typically 1 to 300 kg, more typically 1 to 200 Kg, more typically from 1 to 100 Kg, even more typically from 2 to 50 Kg and especially from 2 to 30 Kg. For animal substrates, the total weight is normally at least about 50 kg, and can be up to about 50,000 kg, typically from about 500 to about 30,000 kg, from about 1000 kg to about 25,000 kg, from about 2000 to about 20,000 kg, or from about 2500 to about 10,000 kg.

The substrate is preferably selected from textiles and animal skin substrates.

The textile may be in the form of an item of clothing such as a coat, jacket, trousers, shirt, skirt, dress, jumper, underwear, hat, scarf, overalls, shorts, swim wear, socks and suits. The textile may also be in the form of a bag, belt, curtains, rug, blanket, sheet or a furniture covering. The textile can also be in the form of a panel, sheet or roll of material which is later used to prepare the finished item or items.

The textile can be or comprise a synthetic fibre, a natural fibre or a combination thereof. The textile can comprise a natural fibre which has undergone one or more chemical modifications. Examples of natural fibres include hair (e.g. wool), silk and cotton. Examples of synthetic textile fibres include Nylon (e.g. Nylon 6,6), acrylic, polyester and blends thereof.

The textile is preferably at least partly coloured, more preferably at least partly dyed. The textile can be dyed with a VAT dye, more preferably a VAT Blue dye and especially an Indigo dye. The present invention has been found to be especially suitable for preventing dye transfer and/or the colour fade of textiles dyed with these dyes. A textile which is often dyed with these dyes (e.g. Indigo dye) is Denim. The textile can be dyed with a Direct dye. Examples of Direct Dyes include Direct Blue 71, Direct Black 22, Direct Red 81.1 and Direct Orange 39. The textile may comprise one or more items having different colours in different regions of the item and/or when two or more textiles are being treated together the textiles may comprise items having different colours. The dye may be chemically attached to the textile. Examples of chemical attachment include covalent bonding, hydrogen bonding and ionic bonding. Alternatively, the dye may be physically adsorbed on the textile.

As used herein, the term “animal skin substrate” includes skins, hides, pelts, leather and fleeces. Typically, the animal skin substrate is a hide or a pelt. The hide or pelt may be a processed or unprocessed animal skin substrate.

The liquid medium is preferably aqueous (i.e. the liquid medium is or comprises water). In order of increasing preference, the liquid medium comprises at least 50 wt %, at least 60 wt %, at least 70 wt %, at least 80 wt %, at least 90 wt %, at least 95 wt % and at least 98 wt % of water.

The liquid medium may optionally comprise one or more organic liquids including for example alcohols, glycols, glycol ethers, amides and esters. Preferably, the sum total of all organic liquids present in the liquid medium is no more than 10 wt %, more preferably no more than 5 wt %, even more preferably no more than 2 wt %, especially no more than 1% and most especially the liquid medium is substantially free from organic liquids.

The liquid medium preferably has a pH of from 3 to 13. The pH or the treatment liquor can differ at different times, points or stages in the treatment method according to the invention.

It can be desirable to treat (particularly to clean) a substrate under alkaline pH conditions, although while higher pH offers improved performance (particularly cleaning performance) it can be less kind to some substrates. Thus, it can be desirable that the liquid medium has a pH of from 7 to 13, more preferably from 7 to 12, even more preferably from 8 to 12 and especially from 9 to 12. In a further preferred embodiment, the pH is from 4 to 12, preferably 5 to 10, especially 6 to 9, and most especially 7 to 9, particularly in order to improve fabric care.

It may also be desirable that the treating of a substrate, or one or more specific stage(s) of a treatment process, is conducted under acid pH conditions. For instance, certain steps in the treatment of animal skin substrates are advantageously conducted at a pH which is typically less than 6.5, even more typically less than 6 and most typically less than 5.5, and typically no less than 1, more typically no less than 2 and most typically no less than 3. Certain fabric or garment finishing treatment methods, for instance stone-washing, may also utilise one or more acidic stage(s).

An acid and/or base may be added in order to obtain the abovementioned pH values. Preferably, the abovementioned pH is maintained for at least a part of the duration, and in some preferred embodiments for all of the duration, of the agitation. In order to prevent the pH of the liquid medium from drifting during the treatment, a buffer may be used.

The present inventors have found that it is possible to use surprisingly small amounts of liquid medium whilst still achieving good treatment performance (particularly cleaning performance). This has environmental benefits in terms of water usage, waste water treatment and the energy required to heat or cool the water to the desired temperature. Preferably, the weight ratio of the liquid medium to the dry substrate is no more than 20:1, more preferably no more than 10:1, especially no more than 5:1, more especially no more than 4.5:1 and even more especially no more than 4:1 and most especially no more than 3:1. Preferably, the weight ratio of liquid medium to the dry substrate is at least 0.1:1, more preferably at least 0.5:1 and especially at least 1:1.

The particles preferably have an average mass of from about 1 mg to about 1000 mg, or from about 1 mg to about 700 mg, or from about 1 mg to about 500 mg, or from about 1 mg to about 300 mg, preferably at least about 10 mg.

Thus, the particles preferably have an average mass of from about 1 mg to about 150 mg, or from about 1 mg to about 70 mg, or from about 1 mg to about 50 mg, or from about 1 mg to about 35 mg, or from about 10 mg to about 30 mg, or from about 12 mg to about 25 mg.

In an alternative embodiment, the particles preferably have an average mass of from about 10 mg to about 800 mg, or from about 20 mg to about 700 mg, or from about 50 mg to about 700 mg, or from about 70 mg to about 600 mg from about 20 mg to about 600 mg. In one preferred embodiment, the particles have an average mass of about 25 to about 150 mg, preferably from about 40 to about 80 mg. In a further preferred embodiment, the particles have an average mass of from about 150 to about 500 mg, preferably from about 150 to about 300 mg.

The average volume of the particles is preferably in the range of from about 5 to about 500 mm³, from about 5 to about 275 mm³, from about 8 to about 140 mm³, or from about 10 to about 120 mm³, or at least 40 mm³, for instance from about 40 to about 500 mm³, or from about 40 to about 275 mm³.

The particles preferably have an average particle size of at least 1 mm, more preferably at least 2 mm and especially at least 3 mm. The particles preferably have an average particle size no more than 100 mm, more preferably no more than 70 mm, more preferably no more than 50 mm, even more preferably no more than 40 mm, yet more preferably no more than 30 mm, still more preferably no more than 20 mm and most preferably no more than 10 mm. Preferably, the particles have an average particle size of from 1 to 20 mm, more preferably from 1 to 10 mm. Particles which offer an especially prolonged effectiveness over a number of treatment cycles are those with an average particle size of at least 5 mm, preferably from 5 to 10 mm. The size is preferably the largest linear dimension (length). For a sphere this equates to the diameter. For non-spheres this corresponds to the longest linear dimension. The size is preferably determined using Vernier callipers. The average particle size is preferably a number average. The determination of the average particle size is preferably performed by measuring the particle size of at least 10, more preferably at least 100 particles and especially at least 1000 particles.

The above mentioned particle sizes provide especially good performance (particularly cleaning performance) whilst also permitting the particles to be readily separable from the substrate at the end of the treatment method.

Preferably the polymer of the polymer particles is a thermoplastic polymer.

A thermoplastic as used herein preferably means a material which becomes soft when heated and hard when cooled. This is to be distinguished from thermosets (e.g. rubbers) which will not soften on heating. A more preferred thermoplastic is one which can be used in hot melt compounding and extrusion.

The polymer preferably has a solubility in water of no more than 1 wt %, more preferably no more than 0.1 wt % in water and most preferably the polyamide is insoluble in water.

Preferably the water is at pH 7 and a temperature of 20° C. whilst the solubility test is being performed. The solubility test is preferably performed over a period of 24 hours. The polymer is preferably not degradable. By the words “not degradable” it is preferably meant that the polymer is stable in water without showing any appreciable tendency to dissolve or hydrolyse. For example, the polymer shows no appreciable tendency to dissolve or hydrolyse over a period of 24 hrs in water at pH 7 and at a temperature of 20° C. Preferably a polymer shows no appreciable tendency to dissolve or hydrolyse if no more than about 1 wt %, preferably no more than about 0.1 wt % and preferably none of the polymer dissolves or hydrolyses, preferably under the conditions defined above.

The polymer may be crystalline or amorphous or a mixture thereof.

The polymer can be linear, branched or partly cross-linked (preferably wherein the polymer is still thermoplastic in nature), more preferably the polymer is linear.

The polymer is selected from polyamides and polyesters and copolymers and/or blends thereof, and preferably from polyamides and polyesters.

The polyamide preferably is or comprises an aliphatic or aromatic polyamide, more preferably is or comprises an aliphatic polyamide.

Preferred polyamides are those comprising aliphatic chains, especially C₄-C₁₆, C₄-C₁₂ and C₄-C₁₀ aliphatic chains.

Preferred polyamides are or comprise Nylons. Preferred Nylons include Nylon 4,6, Nylon 4,10, Nylon 5, Nylon 5,10, Nylon 6, Nylon 6,6, Nylon 6/6,6, Nylon 6,6/6,10, Nylon 6,10, Nylon 6,12, Nylon 7, Nylon 9, Nylon 10, Nylon 10,10, Nylon 11, Nylon 12, Nylon 12,12 and copolymers or blends thereof. Of these, Nylon 6, Nylon 6,6 and Nylon 6,10 and copolymers or blends thereof are preferred. It will be appreciated that these Nylon grades of polyamides are not degradable, wherein the word degradable is preferably as defined above.

The polyester may be aliphatic or aromatic, and is preferably derived from an aromatic dicarboxylic acid and a C₁-C₆, preferably C₂-C₄ aliphatic diol. Preferably, the aromatic dicarboxylic acid is selected from terephthalic acid, isophthalic acid, phthalic acid, 1,4-, 2,5-, 2,6- and 2,7-naphthalenedicarboxylic acid, and is preferably terephthalic acid or 2,6-naphthalenedicarboxylic acid, and is most preferably terephthalic acid. The aliphatic diol is preferably ethylene glycol or 1,4-butanediol. Preferred polyesters are selected from polyethylene terephthalate and polybutylene terephthalate. Useful polyesters can have a molecular weight corresponding to an intrinsic viscosity measurement in the range of from about 0.3 to about 1.5 dl/g, as measured by a solution technique such as ASTM D-4603.

The particles preferably have an average density of greater than 1 g/cm³, more preferably greater than 1.1 g/cm³, more preferably greater than 1.2 g/cm³, even more preferably at least 1.25 g/cm³ and especially preferably greater than 1.3 g/cm³. The particles preferably have an average density of no more than 3 g/cm³ and especially no more than 2.5 g/cm³. Preferably, the particles have an average density of from 1.2 to 3 g/cm³. These densities are advantageous for further improving the degree of mechanical action which assists in the treatment process and which can assist in permitting better separation of the particles from the substrate after the treatment.

Preferably, the particles comprise a filler, preferably an inorganic filler, suitably an inorganic mineral filler in particulate form, such as BaSO₄. The filler is preferably present in the particle in an amount of at least 5 wt %, more preferably at least 10 wt %, even more preferably at least 20 wt %, yet more preferably at least 30 wt % and especially at least 40 wt % relative to the total weight of the particle. The filler is typically present in the particle in an amount of no more than 90 wt %, more preferably no more than 85 wt %, even more preferably no more than 80 wt %, yet more preferably no more than 75 wt %, especially no more than 70 wt %, more especially no more than 65 wt % and most especially no more than 60 wt % relative to the total weight of the particle. The weight percentage of filler is preferably established by ashing. Preferred ashing methods include ASTM D2584, D5630 and ISO 3451, and preferably the test method is conducted according to ASTM D5630. For any standards referred to in the present invention, unless specified otherwise, the definitive version of the standard is the most recent version which precedes the priority filing date of this patent application.

Preferably, the polymer particles to which the polyalkylene glycol is covalently attached consists of a matrix of said polymer optionally comprising filler(s) and/or other additives.

Preferably, the matrix of said polymer optionally comprising filler(s) and/or other additives extends throughout the whole volume of the particles to which said polyalkylene glycols are covalently attached.

The particles of the present invention are preferably prepared from a single chemical composition, i.e. said polymer (polyamide and/or polyester) optionally comprising filler(s) and/or other additives. The particles are suitably prepared by melt-extrusion of a single chemical composition. It will be appreciated, therefore, that the polymer particles preferably do not comprise a core and a shell (i.e. they are not “core-shell” particles).

The particles can be substantially spherical, ellipsoidal, cylindrical or cuboid. Particles having shapes which are intermediate between these shapes are also possible. The best results for treatment performance (particularly cleaning performance) and separation performance (separating the substrate from the particles after the treating steps) in combination are typically observed with ellipsoidal particles. Spherical particles tend to separate best but do not treat or clean as effectively. Conversely, cylindrical or cuboid particles separate poorly but treat or clean effectively. Spherical and ellipsoidal particles are particularly useful for improving fabric care according to the present invention because they are less abrasive.

Preferably, the particles are not perfectly spherical. Preferably, the particles have an average aspect ratio of greater than 1, more preferably greater than 1.05, even more preferably greater than 1.07 and especially greater than 1.1. Preferably, the particles have an average aspect ratio of less than 5, more preferably less than 3, even more preferably less than 2, yet more preferably less than 1.7 and especially less than 1.5. The average is preferably a number average. The average is preferably performed on at least 10, more preferably at least 100 particles and especially at least 1000 particles. The aspect ratio for each particle is preferably given by the ratio of the longest linear dimension divided by the shortest linear dimension. This is preferably measured using Vernier Callipers.

A particularly good balance of treating performance (particularly cleaning performance) and substrate care can be achieved when the average aspect ratio is within the abovementioned values. When the particles have a very low aspect ratio (e.g. highly spherical or ball shaped particles) it is observed that the particles do not provide sufficient mechanical action for good treating or cleaning characteristics to develop. When the particles have an aspect ratio which is too high it is observed that the removal of the particles from the substrate becomes more difficult and/or the abrasion on the substrate can become too high leading to unwanted damage to the substrate, particularly wherein the substrate is a textile.

The present invention uses a multiplicity of particles. Typically, the number of particles is no less than 1000, more typically no less than 10,000, even more typically no less than 100,000. A large number of particles is particularly advantageous in preventing creasing and/or for improving the uniformity of treating or cleaning of the substrate, particularly wherein the substrate is a textile.

Preferably, the ratio of particles to dry substrate is at least 0.1, especially at least 0.5 and more especially at least 1:1 w/w. Preferably, the ratio of particles to dry substrate is no more than 30:1, more preferably no more than 20:1, especially no more than 15:1 and more especially no more than 10:1 w/w.

Preferably, the ratio of the particles to dry substrate is from 0.1:1 to 30:1, more preferably from 0.5:1 to 20:1, especially from 1:1 to 15:1 w/w and more especially from 1:1 to 10:1 w/w.

The polyalkylene glycol preferably has the formula HO(R¹—O)ₙR², wherein R¹ is a divalent hydrocarbon group, R² is H or a monovalent hydrocarbon group, and n is an integer of at least 1, preferably at least 5, and preferably no more than about 500.

R¹ may be a linear or branched divalent hydrocarbon group, and is preferably linear. Preferably R¹ contains from 2 to 6 carbon atoms, preferably from 2 to 4 carbon atoms, preferably 2 or 3 carbon atoms, and preferably 2 carbon atoms. Thus, R¹ is preferably selected from an alkylene group —(CH₂)ₘ— where m=2 to 6, preferably 2 to 4, preferably 2 or 3, and preferably 2. R¹ is preferably —CH₂CH₂— or —CH(CH₃)CH₂—.

R² may be a linear or branched monovalent hydrocarbon group. R² preferably contains from 1 to 30, preferably from 1 to 20, preferably from 1 to 10 carbon atoms, and typically at least 2 carbon atoms. In a preferred embodiment, R² contains from 2 to 6 carbon atoms, preferably from 2 to 4 carbon atoms, preferably 2 or 3 carbon atoms, and preferably 2 carbon atoms. Thus, R² is preferably selected from an alkyl group —(CH₂)ₚ—CH₃ where p=1 to 5, preferably 1 to 3, preferably 1 or 2, and preferably 1, and preferably p=m−1. Thus, in a preferred embodiment R² is derived from the same hydrocarbon group as R¹, with an additional hydrogen atom on the terminal carbon atom. Preferably R² is H, methyl, ethyl or propyl, more preferably H, methyl or ethyl.

The value of n is such that the molecular weight (M_{w}; i.e. the weight average) of the polyalkylene glycol is preferably from about 200 to about 10,000, more preferably from about 350 to about 8000, more preferably from about 600 to about 5000, particularly from about 900 to about 2000, more particularly from about 1200 to about 2000 and especially from about 1200 to about 1800 g/mol. Molecular weight determination may be conducted on a Hewlett-Packard 1050 Series HPLC system equipped with two GPC Ultrastyragel columns, 10³ and 10⁴ Å (5 μm mixed, 300 mm×19 mm, Waters Millipore Corporation, Milford, Mass., USA) and THF as mobile phase. The molecular weight is calculated by comparison with the retention times of polystyrene standards.

Preferably n=10 to 350, preferably n is at least about 20, preferably at least about 30, preferably at least about 40, and preferably no more than about 180, preferably no more than about 70, preferably no more than about 65.

The polyalkylene glycol is preferably selected from polyethylene glycol and polypropylene glycol, or copolymers (including block copolymers) thereof, and is preferably polyethylene glycol.

In the solid particles described herein, the polymer matrix of the polymer particles preferably consists of monomeric repeating units linked by amide and/or ester linkages, wherein at least one terminus of at least one polymer chain is terminated by covalently attached polyalkylene glycol at the surface of said polymer particles. Preferably, the polyalkylene glycol is covalently attached at the surface of said polymer particles via an ester bond. Preferably, at least one terminus of at least one polymer chain of the polymer matrix of the polymer particles is terminated with an —(C═O)—O(R¹—O)ₙR² group formed by the covalent attachment of the aforementioned polyalkylene glycol at the surface of said polymer particles.

The solid particle preferably comprises polyalkylene glycol in an amount of at least 0.01 wt %, more preferably at least 0.1 wt %, more preferably at least 0.5 wt %, more preferably at least 1 wt %, more preferably at least 2 wt %, more preferably at least 5 wt % relative to the total weight of the particle.

The solid particle preferably comprises polyalkylene glycol in an amount of no more than 90 wt %, no more than 80 wt %, no more than 70 wt %, no more than 60 wt %, no more than 50 wt %, no more than 40 wt %, no more than 30 wt %, no more than 25 wt %, no more than 20 wt %, and no more than 15 wt % relative to the total weight of the particle. In one embodiment, the solid particle comprises polyalkylene glycol in an amount of no more than 10 wt % relative to the total weight of the particle.

The solid particle preferably comprises polyalkylene glycol in an amount of from 0.1 to 25 wt %, more preferably from 0.5 to 20 wt % and especially from 1 to 15 wt % relative to the total weight of the particle.

The particles may each comprise one type of polyalkylene glycol or two or more types of polyalkylene glycol. Typically, the particles each comprise only one type of polyalkylene glycol.

The particles may be a physical mixture of two or more types of different particle, each one containing a different type of polyalkylene glycol, or some particles containing polyalkylene glycol and other particles not containing polyalkylene glycol.

The particles of the present invention can be manufactured by modification of conventional polymer particles, the preparation of which is well known and documented in the art. The modification of conventional polymer particles may be achieved via any chemical synthetic procedure suitable for covalent attachment of polyalkylene glycols to polyamides and polyesters, preferably in which amide or ester bonds in the polymer particle are cleaved, or hydrolysed, to provide available carboxyl end-groups and amine or hydroxyl end-groups, and wherein the available carboxyl end-groups are then reacted with the polyalkylene glycol. It will be appreciated that the synthetic procedure is suitable to provide such cleavage, or hydrolysis, at the surface of the particle, rather than throughout the polymeric matrix of the particle.

Preferably the polyalkylene glycol is also the solvent for the reaction.

Preferably the chemical synthetic procedure comprises a first stage of acid hydrolysis and a second esterification stage. The synthetic procedure is preferably conducted at elevated temperature, preferably greater than 100° C., preferably at least 105° C., preferably at least 120° C., preferably at least 140° C., and preferably from about 150 to about 170° C. A preferred degree of surface modification of the particles is achieved at these temperatures when the reaction is conducted over a period of several hours, preferably from about 5 to about 7 hours. The acid hydrolysis is preferably conducted in the presence of a suitable catalyst, preferably titanium butoxide. The acid may be any suitable acid, for instance sulfuric acid. The polymer particles and the polyalkylene glycol are reacted in a preferred weight ratio of from 1:0.1 to about 1:5, depending on the degree of surface modification required. Preferably, the polymer particles and the polyalkylene glycol are reacted in a ratio of from about 0.01 to about 1.5 moles polyalkylene glycol per kg of polymer particle.

According to a seventh aspect of the invention, there is provided a process for the manufacture of a solid particle, particularly the particles of the first and second aspects of the invention, said process comprising the steps of:
(i) providing a solid polymer particle; and
(ii) reacting said particle with a polyalkylene glycol such that said polyalkylene glycol becomes covalently attached to said polymer at the surface of said polymer particle, preferably wherein the reaction comprises a catalysed acid hydrolysis reaction, preferably wherein the reaction comprises a first acid hydrolysis stage and a second esterification stage.

According to an eighth aspect of the invention, there is provided a formulation comprising a multiplicity of solid polymer particles, wherein said polymer is selected from polyamide and polyester, wherein a polyalkylene glycol is covalently attached to said polymer at the surface of said polymer particles, and wherein said particle is prepared by a process comprising the steps of:
(i) providing a solid polymer particle; and
(ii) reacting said particle with a polyalkylene glycol such that said polyalkylene glycol becomes covalently attached to said polymer at the surface of said polymer particle, preferably wherein the reaction comprises a catalysed acid hydrolysis reaction, preferably wherein the reaction comprises a first acid hydrolysis stage and a second esterification stage.

Thus, the particles of the present invention are manufactured by a process designed to modify the surface of the polymer particle, rather than the interior of the polymer particle. Preferably, therefore, covalently bound polyalkylene glycol is not located inside the particle.

Preferably, no polyalkylene glycol is located inside the particle.

The term “located inside the particle” means that a material is beneath the surface of the particle, i.e. within the polymer matrix. Similarly, the term “not located inside the particle” means that the material does not reside beneath the surface of the particle, i.e. at the external boundary of the polymer matrix.

However, it is possible that some polyalkylene glycol molecules may find their way into the interior of the polymer matrix of the particle during the synthetic procedure described hereinabove, and become covalently attached to the polymer inside the particle. Such particles remain within the scope of the present invention. Thus, the particles of the first and second aspects of the present invention preferably exhibit a concentration gradient of polyalkylene glycol in the polymeric matrix of the particle from the centre of the particle to the surface of the particle such that the amount of covalently bound polyalkylene glycol at the surface (defined herein as M_{PAG-S}) is greater than the amount of covalently bound polyalkylene glycol inside the particle (defined herein as M_{PAG-I}). Preferably, the ratio M_{PAG-S}:M_{PAG-I} is at least at least 1.5:1, preferably at least 2:1, preferably at least 3:1, preferably at least 4:1, preferably at least 5:1, preferably at least 6:1, preferably at least 7:1, preferably at least 8:1, preferably at least 9:1, preferably at least 10:1, preferably at least 20:1, preferably at least 50:1, preferably at least 100:1, preferably at least 500:1, and preferably at least 1000:1.

Preferably, all or substantially all covalently bound polyalkylene glycol is covalently attached to said polymer at the surface of the particle.

As used herein, the term “surface of the particle” preferably refers to the region which is the outer 100 μm, preferably the outer 50 μm, preferably the outer 25 μm, preferably the outer 10 μm, preferably the outer 5 μm, and preferably the outer 1 μm of the particle (in particular of the polymer matrix of the particle).

The solid particles suitably do not contain a polyether block polyamide inside the particle.

Preferably, the polyalkylene glycol is dispersed across the whole surface of each particle. Preferably, the polyalkylene glycol is dispersed substantially uniformly across the whole surface of each particle.

It will be appreciated that the benefit of the invention is attained by virtue of the combination of the polyalkylene glycol and the polymer particle, and the covalent attachment therebetween. Thus, it will be appreciated that the invention benefits from the covalent attachment of at least one end of the polyalkylene glycol to the polymer particle wherein any remaining end(s) (and, in respect of the preferred linear polyalkylene glycols, the other end) of the polyalkylene glycol is not bound to an additional functional component (for instance, a deposition aid such as a deposition aid comprising a peptide, protein, copolymer incorporating a protein or mixture thereof). Thus, preferably, in the particles described herein, said polyalkylene glycol which is covalently attached via a first end of said polyalkylene glycol to said polymer at the surface of said polymer particles is not attached at the second or further end(s) of the polyalkylene glycol to a functional component such as those described immediately hereinabove. The second or further end(s) of the polyalkylene glycol may be covalently attached to a polymer of the polymer particle. Preferably, the polyalkylene glycols exhibit a hydrogen or monovalent hydrocarbon group (as defined for R² hereinabove) at the opposite end(s) of the polyalkylene glycol chain relative to the point of covalent attachment to a polymer of the polymer particle. In other words, for a polyalkylene glycol which is covalently attached via a first end of said polyalkylene glycol to a polymer at the surface of said polymer particles, the second or further end(s) of the polyalkylene glycol exhibits a hydrogen or monovalent hydrocarbon group or may be covalently attached to a polymer of the polymer particle (the same or different polymer of the polymer particle). It will be appreciated that the preferred polyalkylene glycols used to prepare the particles of the present invention do not contain a free terminal NH₂ group or any other amine group. Thus, preferably the polyalkylene glycol chains in the particles of the present invention do not contain any amine-derived linkages or nitrogen-containing groups at any location other than at the point of covalent attachment of the polyalkylene glycol to a polyamide.

The amount of polyalkylene glycol on the particles can be determined by conventional methods, for instance mass spectroscopy, atomic absorption spectroscopy, infra-red, UV and NMR spectroscopy.

Semi-quantitative methods to establish the location of the polyalkylene glycol include sectioning the particles and using methods such as visible microscopy or more preferably scanning electron microscopy (SEM). In the case of SEM it is also possible to use energy-dispersive x-ray spectroscopy so as to help identify the locations of the polyalkylene glycol. Atomic force microscopy (AFM) can also be used.

In the present invention, the polyalkylene glycol is preferably still present in the particle after at least 5, preferably at least 10, preferably at least 20, preferably at least 50, preferably at least 100, preferably after at least 200, preferably after at least 300, preferably after at least 400 and preferably after at least 500 treatment cycles. A treatment cycle ends after the particles are separated from the substrate. Preferably, the particles still comprise at least 10 wt %, at least 25 wt %, at least 50 wt %, at least 60 wt %, at least 80 wt %, at least 90 wt %, at least 95 wt %, at least 98 wt %, at least 99 wt %, and preferably substantially all of the original amount of polyalkylene glycol after the above mentioned numbers of cycles.

In the methods and uses of the invention described herein, the substrate is agitated with a formulation comprising a multiplicity of solid particles as described herein, a liquid medium, and preferably also a detergent composition. The detergent composition may comprise any one or more of the following components: surfactants, dye transfer inhibitors, builders, enzymes, metal chelating agents, biocides, solvents, stabilizers, acids, bases and buffers. In particular, the detergent composition may comprise one or more enzyme(s).

The detergent composition can be free of the polyalkylene glycol present on the cleaning particle, or if not completely free of polyalkylene glycol then the detergent composition comprises less than 1 wt %, more preferably less than 0.5 wt % and especially less than 0.1 wt % of polyalkylene glycol.

The treatment method or process of the present invention agitates the substrate in the presence of the formulation, a liquid medium and, where the treatment method is a cleaning method, preferably also a detergent composition. The agitation may be in the form of shaking, stirring, jetting and tumbling. Of these, tumbling is especially preferred. Preferably, the substrate and the formulation, liquid medium and optional detergent are placed into a rotatable treatment chamber which is rotated so as to cause tumbling. The rotation can be such as to provide a centripetal force of from 0.05 to 1 G and especially from 0.05 to 0.7 G. When the treatment method is performed in an apparatus comprising a chamber which is a drum the centripetal force is preferably as calculated at the interior walls of the drum furthest away from the axis of rotation.

The agitation may be continuous or intermittent. Preferably, the method is performed for a period of from 1 minute to 10 hours, more preferably from 5 minutes to 3 hours and even more preferably from 10 minutes to 2 hours.

The particles are able to contact the substrate, suitably mixing with the substrate during the agitation.

The treatment method or process according to the present invention is preferably performed at a temperature of from greater than 0° C. to about 95° C., preferably from 5 to 95° C., preferably at least 10° C., preferably at least 15° C., preferably no more than 90° C., preferably no more than 70° C., and advantageously no more 50° C., no more than 40° C. or no more than 30° C. Such milder temperatures allow the particles to provide the afore-mentioned benefits over larger numbers of treatment cycles. Preferably, when several batches or washloads are treated or cleaned, every treating or cleaning cycle is performed at no more than a temperature of 95° C., more preferably at no more than 90° C., even more preferably at no more than 80° C., especially at no more than 70° C., more especially at no more than 60° C. and most especially at no more than 50° C., and from greater than 0° C., preferably at least 5° C., preferably at least 10° C., preferably at least 15° C., preferably from greater than 0 to 50° C., greater than 0 to 40° C., or greater than 0 to 30° C., and advantageously from 15 to 50° C., 15 to 40° C. or 15 to 30° C. These lower temperatures again allow the particles to provide the benefits for a larger number of treatment or wash cycles.

The cleaning method or process is preferably a laundry cleaning method.

The cleaning method or process may additionally comprise one or more of the steps including: separating the particles from the cleaned substrate; rinsing the cleaned substrate;

post-cleaning treatment; removing the liquid medium from the cleaned substrate; removing the substrate from the apparatus; and drying the cleaned substrate.

Preferably, the particles are re-used in further treating or cleaning procedures. In order of increasing preference, the particles can be re-used for at least 2, at least 3, at least 5, at least 10, at least 20, at least 50, at least 100, at least 200, at least 300, at least 400 and at least 500 treating or cleaning procedures.

It will be appreciated that the duration and temperature conditions described hereinabove are associated with the treating or cleaning of an individual batch or washload comprising at least one of said substrate(s).

It will be appreciated that the agitation of the batch or washload with said treating or cleaning formulation suitably takes place in said one or more discrete treating or cleaning step(s) of the aforementioned treatment or cleaning cycle. Thus, the duration and temperature conditions described hereinabove are preferably associated with the step of agitating the batch or washload comprising at least one of said substrate(s) with said formulation, liquid medium and optional detergent composition, i.e. said one or more discrete treating or cleaning step(s) of the aforementioned treatment or cleaning cycle.

It is preferred that the treatment or cleaning method or process described hereinabove additionally comprises: separating the particles from treated or cleaned substrate. Preferably, the particles are stored in a particle storage tank for use in the next treatment or cleaning procedure.

The treatment or cleaning method or process described hereinabove may comprise the additional step of rinsing the treated or cleaned substrate. Rinsing is preferably performed by adding a rinsing liquid medium to the treated or cleaned substrate. The rinsing liquid medium preferably is or comprises water. Optional post-cleaning additives which may be present in the rinsing liquid medium include optical brightening agents, fragrances and fabric softeners.

According to an ninth aspect of the invention, there is provided an apparatus suitable for performing the methods of the third or fourth aspects of the invention, wherein said apparatus comprises a rotatable treatment chamber and one or more particle storage compartment(s) containing the solid particles defined hereinabove.

The rotatable treatment chamber is preferably a drum.

In a preferred embodiment, the treatment chamber or drum is provided with perforations which allow the particles to exit the treatment chamber or drum. In a further preferred embodiment, additional or alternative to the immediately preceding preferred embodiment, the particles may exit the treatment chamber or drum via lifters disposed on the interior walls of the treatment chamber or drum.

As used herein, the term “lifter” refers to an elongated protrusion affixed essentially perpendicularly to the inner surface of the cylindrical side walls of a rotatably mounted cylindrical drum, which functions as a circulation means to aid the circulation and agitation of the substrate(s) in the drum. The drum preferably comprises a multiplicity of spaced apart elongated protrusions, the number depending on the diameter of the drum. For a domestic or industrial laundry machine, there are typically from 3 to 10, most preferably 4, of said protrusions. In operation, agitation of the contents of the rotatably mounted cylindrical drum is provided by the action of the lifters on the substrate(s) during rotation of the drum.

The apparatus preferably additionally comprises a pump for transferring the particles into the treatment chamber. Alternatively or additionally, the apparatus may comprise a rotatable treatment chamber (or drum) which itself comprises one or more particle storage compartment(s), especially wherein the particle storage compartment(s) is/are located in lifters and/or in the rear of the chamber furthest from the door. Where the drum comprises particle storage compartment(s) located in the lifters, it is not necessary for the lifters to function as conduits to allow the particles to exit the treatment chamber or drum, and in a preferred embodiment the lifters do not allow the particles to exit the drum and instead function as particle storage compartment(s). Where the apparatus comprises a rotatable treatment chamber (or drum) which itself comprises one or more particle storage compartment(s), the apparatus advantageously avoids the need for a pump for transferring particles into the treatment chamber.

The preferred apparatus is as described in WO2011/098815 wherein the second lower chamber contains the particles as defined in the first aspect of the present invention.

In the present invention the words “a” and “an” mean one or more. Thus, by way of examples a textile means one or more textiles, equally a “polymer” means one or more polymers and a “polyalkylene glycol” means one or more polyalkylene glycols.

The invention is further illustrated by reference to the following examples. The examples are not intended to limit the scope of the invention as described above.

### EXAMPLES

### Example 1

Thermoplastic Nylon-6 cleaning particles (4.3 mm; filled with BaSO₄ and having a density of 1.65 g/cm³) were used as the starting material. The particles were reacted with PEG-1500 by mixing 1 kg of the particles, 1.2 kg of PEG-1500, 3 ml of 95% sulfuric acid, 5 ml of titanium butoxide, and heating the mixture at 160° C. for 5-7 hours with stirring.

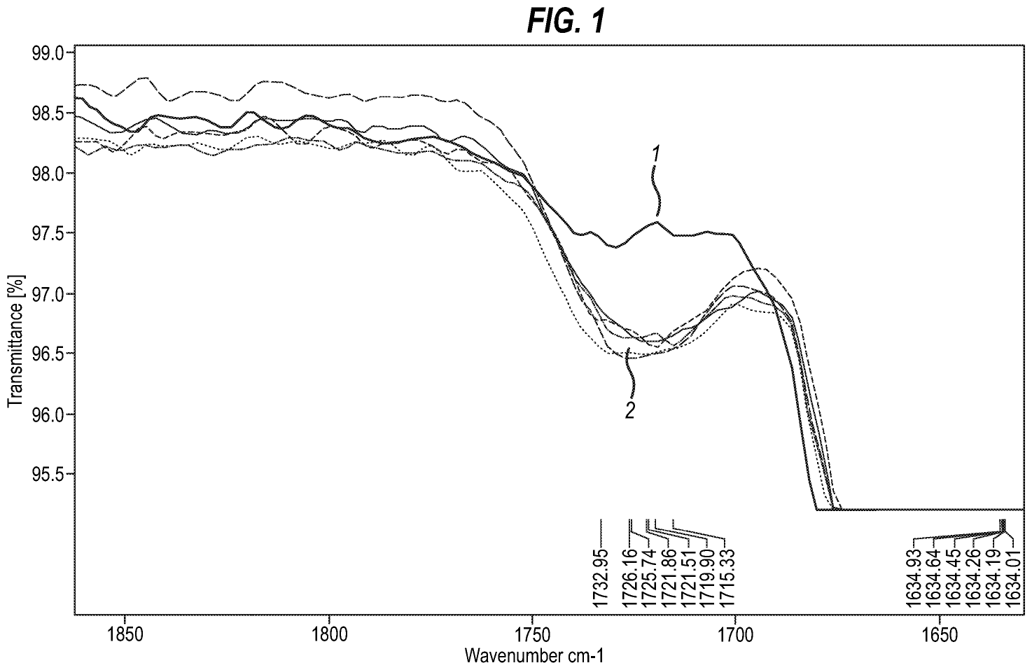

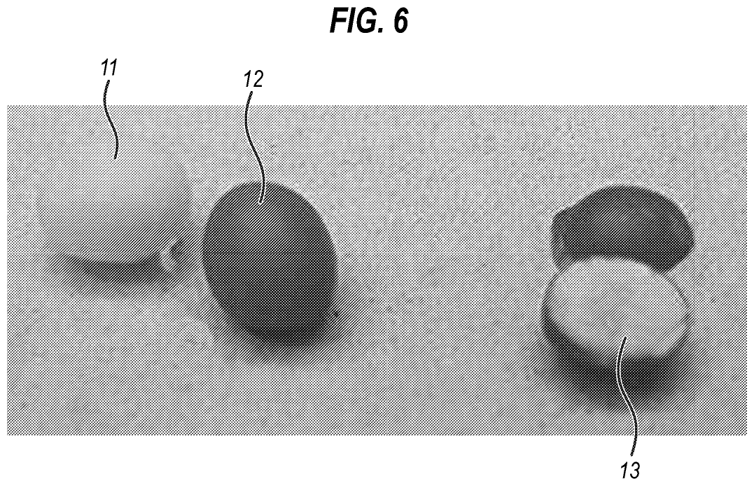

By removing 2-3 particles every hour and analysing them by Fourier Transform Infra-Red (FTIR) spectroscopy, the reaction was followed through the hydrolysis of the amide bond to carboxylic acid, to the formation of the ester bond between the acid group on the particle and the hydroxyl group of the PEG. The FTIR confirmed that PEG was covalently attached to the carboxylic acid through an ester bond by the appearance of a distinctive absorption band in the range of about 1715 to about 1735 cm⁻¹. The Nylon-6 particles used as the starting material contained no ester bonds present, and no peak in this area. FIG. 1 shows the difference between the starting material (1) and the PEGylated particles (2), which show the absorption band. FIG. 6 shows a photograph of the starting material (11) and the PEGylated particles (12, 13), wherein the PEGylated particle (13) is shown sliced in half.

X-Ray Photoelectron Spectroscopy (XPS) confirmed the presence of the ester bond in the reaction product, and quantified the amount of ester bonds as being 1.3% of the total bonds. The XPS results also demonstrated that the ratio of carbon to oxygen had changed significantly from the starting material to the PEGylated particles. It was found that the C:O ratio in the starting material is 5.8:1 while that in the PEGylated particles were 2.5:1.

### Reference Example 1

A cleaning particle was prepared by co-extruding thermoplastic polyamide with polyether block polyamide in accordance with Example 4 of WO2017/017455. The cleaning particle also contained an inorganic mineral filler such that the weight ratio was 25:25:50 polyamide:polyether block polyamide:filler.

Performance in Cleaning Methods

The performance of the particles of Example 1 and Reference Example 1 was assessed in repeated cleaning tests using a Xeros washing apparatus as described in PCT patent publication WO 2011/098815. The conventional thermoplastic polyamide particles (i.e. the starting material noted above) were used as a Control.

The cleaning cycle was run at a temperature of 20° C. using 29.6 g detergent composition (Tide (US formulation); Proctor & Gamble). For each cleaning cycle, 4 kg of cleaning particles were used in each case. The liquid medium was water. The cleaning step of the cleaning cycle was run for 20 minutes. After the cleaning step, the wash load was rinsed and the washing apparatus performed a separation cycle for a period of 35 minutes (including rinse and separations steps). The total cycle time was about 55 minutes.

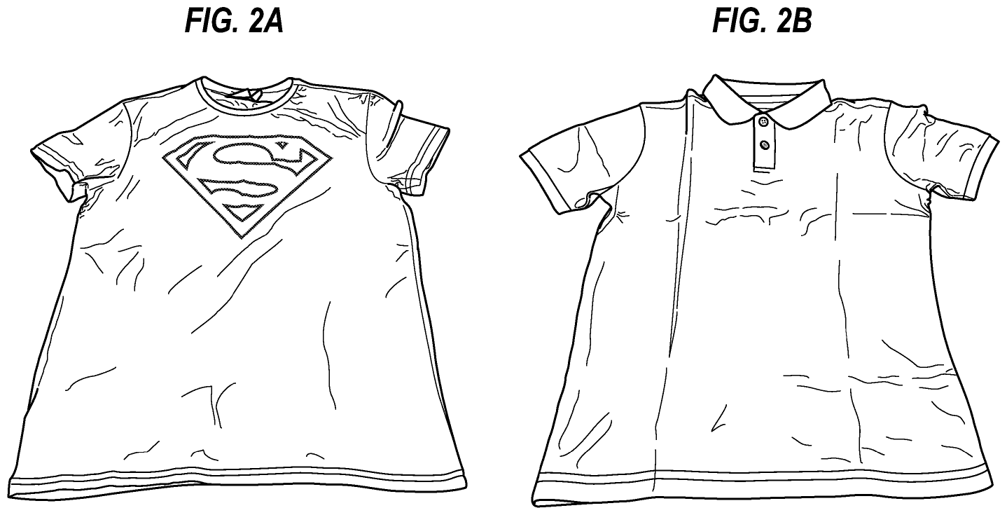

Each cleaning cycle was carried out using the garments shown in FIGS. 2A and 2B); identical garments were used for each particle type. The garment shown in FIG. 2A was selected in order to assess damage to transfers, i.e. where the design is not woven into the garment but attached to the surface of the fabric by adhesive as a sticker or transfer, which are commonly damaged in traditional washing machines. The polo shirt shown in FIG. 2B is a garment made from man-made-fibre which was known to shrink significantly during conventional wash cycles. These garments plus some additional polyester squares (to a total weight of 3.6 kg) were then washed in 10 cleaning cycles.

The washed garments were flat dried overnight and analysed in terms of length, width and colour after 2, 6 and 10 cycles.

A further wash performance test was conducted using the PEGylated particles of Example 1 after they had been run through accelerated ageing of 100 cycles, i.e. in this further test, the PEGylated particles experienced cleaning cycles 101 to 110.

Damage to the transfers on the garments was assessed visually and by touch. Shrinkage was measured with a tape measure and the measurement points are marked on the garment in permanent marker to ensure the same measurements are being taken every time.

The transfer of the garment washed using the PEGylated particles of Example 1 exhibited less damage, in terms of its visual appearance, compared to the transfer washed using the particles of Reference Example 1. In the touch test, the feel of the transfer washed by the PEGylated particles of Example 1 remained thick and sticky (in the same way as the unwashed garment), while the transfer washed by the particles of Reference Example 1 felt softer as if it has been worn down to the cotton underneath.

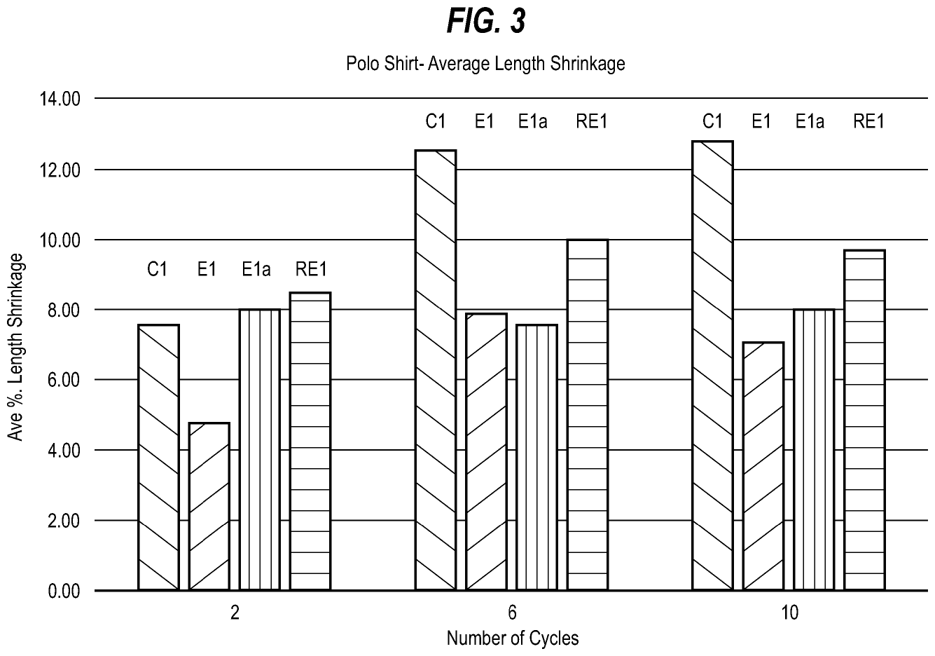

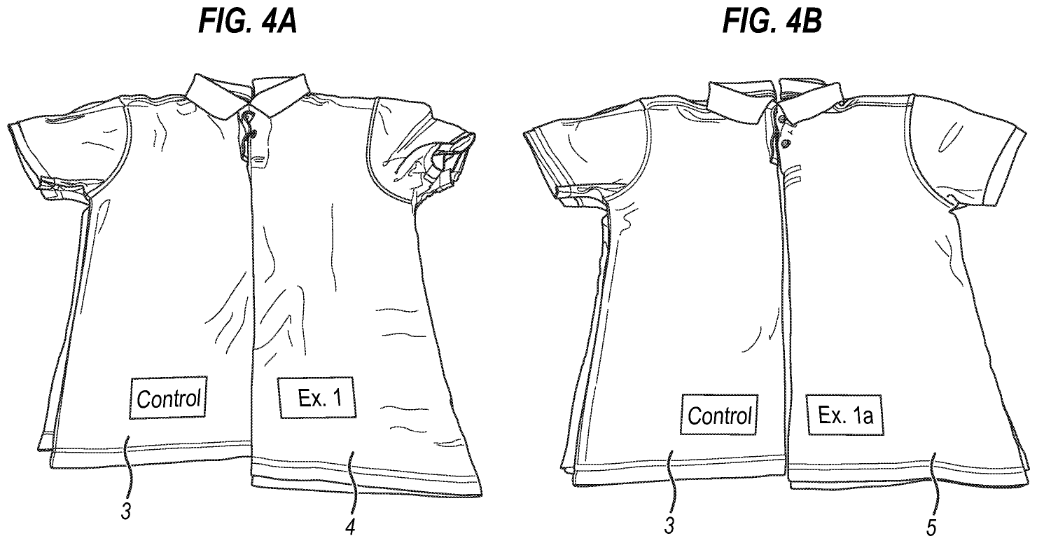

In order to assess the shrinkage of the polo shirt, the length and width were measured in multiple areas and the average is shown as bar chart in FIG. 3 (in which: C1 refers to the unmodified Control particles; E1 refers to the particles of Example 1; E1a refers to the particles of Example 1 after accelerated ageing for 100 cycles); and RE1 refers to Reference Example 1. FIGS. 4A and 4B demonstrate visually the difference in shrinkage of the garment washed for 10 cycles by the different particles, wherein garment (3) was washed by the unmodified Control particles; garment (4) was washed by the particles of Example 1; and garment (5) was washed by the particles of Example 1 after accelerated ageing (100 cycles).

The experiments demonstrate that the particles of Example 1, whether they are virgin particles or aged particles, surprisingly produce much lower shrinkage than the particles of Reference Example 1 or the Control example (unmodified). The unmodified particles of the Control experiment already provide lower shrinkage and comparable or superior cleaning performance in cleaning cycles as described above when compared to particle-free conventional washing machines.

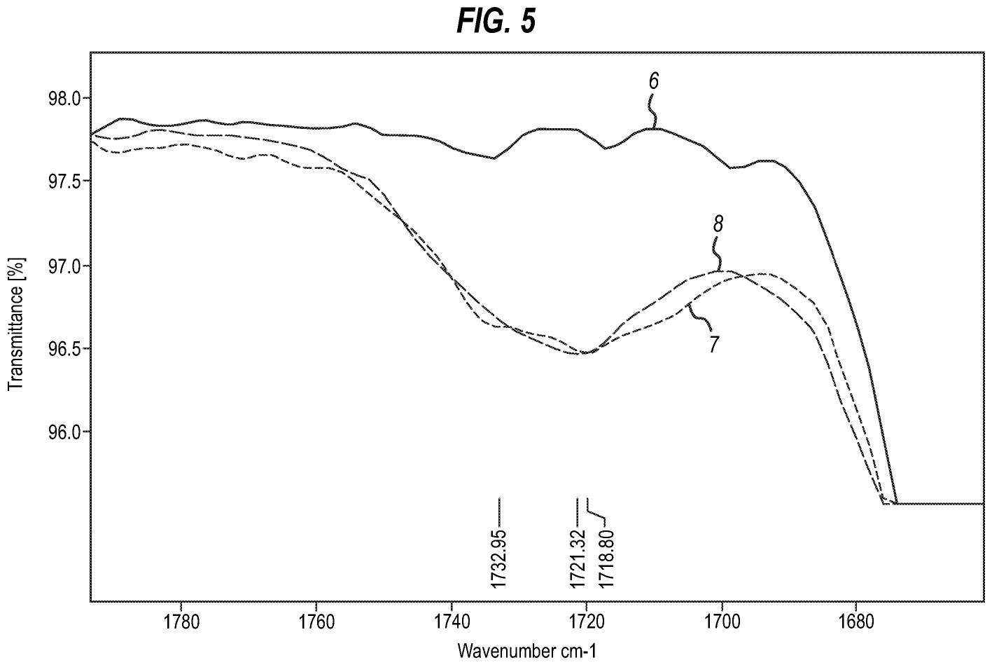

The PEGylated particles of Example 1 were also analysed by FTIR spectroscopy immediately after the first 10 cycles of use and then again after they had been run through accelerated ageing of 100 cycles, and in each case, the same ester absorption band identified in the virgin PEGylated particles was clearly visible. The FTIR spectra presented in FIG. 5 show: the FTIR spectrum (6) of the unmodified particles (starting material); the FTIR spectrum (7) of the virgin PEGylated particles of Example 1; and the FTIR spectrum (8) of the aged PEGylated particles of Example 1 (110 cycles). The FTIR spectra clearly demonstrate the retention of the covalent bond between PEG and the polyamide upon repeated cleaning cycles.

1. A formulation comprising a multiplicity of solid polymer particles, wherein said polymer is selected from polyamide and polyester, wherein a polyalkylene glycol is covalently attached to said polymer at the surface of said polymer particles.

2. A formulation according to claim 1 wherein the polymer matrix of said polymer particles consists of monomeric repeating units linked by amide and/or ester linkages, wherein at least one terminus of at least one polymer chain is terminated by said covalently attached polyalkylene glycol at the surface of said polymer particles.

3. A formulation according to claim 1 wherein a polyalkylene glycol is covalently attached to said polymer at the surface of said polymer particles such that the polymer matrix of said polymer particles consists of monomeric repeating units linked by amide and/or ester linkages, wherein at least one terminus of at least one polymer chain is terminated by said covalently attached polyalkylene glycol at the surface of said polymer particles.

4. A formulation according to claim 1, 2 or 3 wherein the amount M_{PAG-S} of covalently bound polyalkylene glycol at the surface is greater than the amount M_{PAG-I} of covalently bound polyalkylene glycol inside the particle, preferably wherein the ratio M_{PAG-S}:M_{PAG-I} is at least 10:1.

5. A formulation according to any preceding claim wherein covalently bound polyalkylene glycol is not located inside the particle, preferably wherein polyalkylene glycol is not located inside the particle

6. A formulation according to any preceding claim wherein said polyalkylene glycol is covalently attached at the surface of said polymer particles via an ester bond.

7. A formulation according to any preceding claim wherein said polyalkylene glycol has formula HO(R¹—O)ₙR² and at least one terminus of at least one polymer chain of the polymer matrix of said polymer particles is terminated with an —(C═O)—O(R¹—O)ₙR² group formed by the covalent attachment of said polyalkylene glycol at the surface of said polymer particles, wherein R¹ is a divalent hydrocarbon group, R² is H or a monovalent hydrocarbon group, and n is an integer of at least 1, preferably at least 5, and preferably no more than about 500.

8. A formulation according to any preceding claim wherein said polyalkylene glycol has formula HO(R¹—O)ₙR² wherein R¹ is a divalent hydrocarbon group containing from 2 to 6 carbon atoms; and R² is H or a monovalent hydrocarbon group containing from 1 to 30 carbon atoms, and n is an integer of at least 1, preferably at least 5, and preferably no more than about 500.

9. A formulation according to claim 7 or 8 wherein R¹ is —CH₂CH₂— or —CH(CH₃)CH₂—, and/or R² is H, methyl, ethyl or propyl, and/or n=30 to 180.

10. A formulation according to any preceding claim wherein said polyalkylene glycol has a molecular weight M_{w} from about 200 to about 10,000, more preferably from about 350 to about 8000, more preferably from about 600 to about 5000, particularly from about 900 to about 2000, and especially from about 1200 to about 1800 g/mol.

11. A formulation according to any preceding claim wherein said polyalkylene glycol is linear.

12. A formulation according to any preceding claim wherein the polyalkylene glycol is or comprises polyethylene glycol.

13. A formulation according to any preceding claim wherein said polymer is a thermoplastic polymer.

14. A formulation according to any preceding claim wherein said polymer is a polyamide.

15. A formulation according to any preceding claim wherein said polymer is or comprises an aliphatic or aromatic polyamide, preferably an aliphatic polyamide

16. A formulation according to any preceding claim wherein the polyamide is or comprises Nylon 4,6, Nylon 4,10, Nylon 5, Nylon 5,10, Nylon 6, Nylon 6,6, Nylon 6/6,6, Nylon 6,6/6,10, Nylon 6,10, Nylon 6,12, Nylon 7, Nylon 9, Nylon 10, Nylon 10,10, Nylon 11, Nylon 12, Nylon 12,12 and copolymers or blends thereof.

17. A formulation according to any preceding claim wherein the polyamide is or comprises Nylon 6, Nylon 6,6, Nylon 6,10 and copolymers or blends thereof.

18. A formulation according to any of claims 1 to 12 wherein said polymer is a polyester is selected from polyethylene terephthalate and polybutylene terephthalate.

19. A formulation according to any preceding claim wherein the particles comprise an inorganic filler.

20. A formulation according to any preceding claim wherein the particles have an average density of at least 1.25 g/cm³.

21. A formulation according to any preceding claim wherein the particles have an average particle size of from 1 to 20 mm.

22. A formulation according to any preceding claim wherein the particles are ellipsoidal, spherical, cylindrical or cuboid.

23. A formulation according to any preceding claim wherein said polyalkylene glycol is present in an amount of at least 1 wt % and/or no more than 15 wt % relative to the total weight of the particle.

24. A formulation according to any preceding claim which is a cleaning formulation.

25. A method for treating a substrate, the method comprising agitating the substrate with a formulation according to any of claims 1 to 24 and a liquid medium.

26. A method according to claim 25 wherein the particles are re-used in further treatment procedures according to the method.

27. A method according to claim 25 or 26 wherein the method is a method for treating multiple batches, wherein a batch comprises at least one substrate, the method comprising agitating a first batch with a formulation according to any one of claims 1 to 24 and a liquid medium, wherein said method further comprises the steps of:
(a) recovering said particles;
(b) agitating a second batch comprising at least one substrate and a formulation comprising the particles recovered from step (a) and a liquid medium; and
(c) optionally repeating steps (a) and (b) for subsequent batch(es) comprising at least one substrate.

28. A method according to claim 25, 26 or 27 wherein the particles are re-used for at least 10, and preferably at least 100, treatment procedures according to the method.

29. A method according to any of claims 25 to 28 wherein the liquid medium is aqueous.

30. A method according to any one of claims 25 to 29 which is performed at a temperature of from 5 to 50° C.

31. A method according to any of claims 25 to 30 wherein the substrate is or comprises a textile.

32. A method according to claim 31 wherein the treating of said substrate is cleaning, coloration, bleaching, abrading or ageing, or other textile or garment finishing process.

33. A method according to any of claims 25 to 32 for cleaning a substrate which is or comprises a textile, the method comprising agitating the substrate with a cleaning formulation according to any of claims 1 to 24, and a liquid medium, and optionally a detergent composition.

34. A method according to claim 33 wherein the substrate is a soiled substrate.

35. A method according to claim 33 or 34 which is a method for cleaning multiple washloads, wherein a washload comprises at least one substrate which is or comprises a textile, the method comprising agitating a first washload with a cleaning formulation according to any of claims 1 to 24 and a liquid medium, wherein said method further comprises the steps of:
(a) recovering said particles;
(b) agitating a second washload comprising at least one substrate and a cleaning formulation comprising the particles recovered from step (a) and a liquid medium, wherein said substrate is or comprises a textile; and
(c) optionally repeating steps (a) and (b) for subsequent washload(s) comprising at least one substrate which is or comprises a textile.

36. A method according to any of claims 25 to 30 wherein the substrate is or comprises an animal skin substrate.

37. A method according to claim 36 wherein the treating of an animal skin substrate is a tannery process.

38. A method of reducing the mechanical damage and/or shrinkage and/or colour fade of a substrate in a treatment process which comprises agitating the substrate with solid polymeric particles and a liquid medium, wherein the method comprises agitating said substrate with a formulation according to any of claims 1 to 24 and a liquid medium.

39. Use of a formulation according to any of claims 1 to 24 for treating a substrate.

40. Use of a formulation according to any of claims 1 to 24 for reducing the mechanical damage and/or shrinkage and/or colour fade of a substrate in a treatment process which comprises agitating the substrate with said formulation and a liquid medium.

41. A method according to claim 38 or 39 or a use according to claim 40 wherein said treating and said substrate are as defined in any of claims 25 to 37.

42. An apparatus suitable for performing the method of any one of claims 25 to 38 wherein the apparatus comprises a rotatable treatment chamber and one or more particle storage compartment(s) containing the particles as defined in any one of claims 1 to 24.

43. An apparatus according to claim 42 wherein the rotatable treatment chamber is a drum provided with perforations which allow the particles to exit the drum.

44. An apparatus according to claim 42 or 43 embodiment, the rotatable treatment chamber is a drum provided with lifters on the interior walls of the drum, optionally wherein the particles may exit the drum via said lifters, and wherein a lifter is defined as an elongated protrusion affixed perpendicularly to the inner walls of the drum.

45. An apparatus according to claim 42, 43 or 44 which additionally comprises a pump for transferring the particles into the treatment chamber.

46. An apparatus according to claim 42, 43 or 44 wherein the rotatable treatment chamber itself comprises one or more particle storage compartment(s).

47. An apparatus according to claim 46 wherein the particle storage compartment(s) is/are located in lifters which do not function as conduits to allow the particles to exit the treatment chamber.

48. A process for the manufacture of a solid particle comprising the steps of:
(i) providing a solid polymer particle; and
(ii) reacting said particle with a polyalkylene glycol such that said polyalkylene glycol becomes covalently attached to said polymer at the surface of said polymer particle, preferably wherein the reaction comprises acid hydrolysis conducted at a temperature of greater than 100° C., preferably in the presence of a catalyst, and preferably wherein the polyalkylene glycol is also the solvent for the reaction.

49. A process according to claim 48 wherein the polymer particle and the polyalkylene glycol are reacted in a ratio of from about 0.01 to about 1.5 moles polyalkylene glycol per kg of polymer particles.

50. A process according to claim 48 or 49 wherein the polyalkylene glycol and/or the polymer and/or the solid particle reaction product is as defined in any of claims 1 to 24.

51. A formulation according to any of claims 1 to 24 wherein said particle is prepared by a process comprising the steps of:
(i) providing a solid polymer particle; and
(ii) reacting said particle with a polyalkylene glycol such that said polyalkylene glycol becomes covalently attached to said polymer at the surface of said polymer particle, preferably wherein the reaction comprises a catalysed acid hydrolysis reaction, preferably wherein the reaction comprises a first acid hydrolysis stage and a second esterification stage.
